(19) United States
(12) Patent Application Publication
(10) Pub. No.: US 2013/0055101 A1
(43) Pub. Date: Feb. 28, 2013

(54) System and Method for Tagging Belongings in Photos and Posts

(71) Applicant: Zaheed Md Shahjahan Sabur, Adliswil (CH)

(72) Inventor: Zaheed Md Shahjahan Sabur, Adliswil (CH)

(73) Assignee: Google Inc., Mountain View, CA (US)

(21) Appl. No.: 13/221,720

(22) Filed: Aug. 30, 2011

(51) Int. Cl. G06F 3/048; G06F 15/16

(52) U.S. Cl. 715/739

(57) ABSTRACT

A system and machine-implemented method is provided for tagging of belongings maintained within a social graph of belongings in photos and posts including receiving a request to tag a belonging within a selected area of a display from a user of a system, providing, in response to the request, a list of belongings including the one or more belongings associated with the user within the social graph of belongings, wherein the social graph of belongings defines an association between each of the one or more users and one or more belongings, receiving an indication of a user selection of a first belonging from the list of belongings, generating a link corresponding to the first belonging in response to receiving the indication of the user selection and associating the link with the selected area.

### BACKGROUND

The subject disclosure generally relates to tagging photos and posts, and, in particular, to tagging products displayed within a photo or mentioned within a post.

Currently, users of social networking sites can tag individuals in pictures and posts by selecting the name of the individual from their list of contacts. Once an individual is tagged in a post, users can click on the tagged individual's name to view his/her profile. It may be similarly desirable for users to get further information on products displayed within a photo, e.g. clothing or accessories worn by the individuals in the picture, or, mentioned within a post.

It may be desirable to provide an option for tagging products/belongings displayed or discussed within a photo or post. Thus, a convenient way for tagging products within photos and posts may be desirable.

### SUMMARY

The disclosed subject matter relates to a machine-implemented method for tagging of belongings maintained within a social graph of belongings in photos and posts, the method comprising receiving a request to tag a belonging within a selected area of a display from a user of a system. The method further comprising providing, in response to the request, a list of belongings comprising the one or more belongings associated with the user within the social graph of belongings, wherein the social graph of belongings defines an association between each of the one or more users and one or more belongings. The method further comprising receiving an indication of a user selection of a first belonging from the list of belongings. The method further comprising generating a link corresponding to the first belonging in response to receiving the indication of the user selection and associating the link with the selected area

The disclosed subject matter also relates to a system for tagging of belongings maintained within a social graph of belongings in photos and posts, the system comprising one or more processors and a machine-readable medium comprising instructions stored therein, which when executed by the processors, cause the processors to perform operations comprising receiving a request to tag a belonging within one of a photo or a post from a user of a system. The operations further comprising providing one or more belongings to the user in response to the request, wherein the one or more belongings are referenced within a social graph of belongings, wherein the social graph of belongings defines an association between one or more users including the user of the system and one or more belongings. The operations further comprising receiving a selection of a first belonging of the provided one or more belongings from the user. The operations further comprising generating a link corresponding to the first belonging in response to the selection and associating the link with the one of the photo and the post.

The disclosed subject matter also relates to a machine-readable medium comprising instructions stored therein, which when executed by a machine, cause the machine to perform operations comprising receiving a request to tag a belonging within a selected area of one of a photo or a post from a user. The operations further comprising retrieving a list of belongings, the list of belongings comprising the one or more belongings associated with the user within a social graph of belongings, wherein the social graph of belongings defines an association between each of the one or more users including the user and one or more belongings, each of the one or more belongings being associated with a belonging profile. The operations further comprising providing the list of belongings in response to the request. The operations further comprising receiving a selection of a first belonging from the list of belongings from the user. The operations further comprising generating a link corresponding to the first belonging in response to the selection, wherein the link is selectable and configured to access and display the belonging profile associated with the first belonging upon selection and associating the link with the selected area.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment, which provides for managing belonging-related information using a social graph of belongings.

FIG. 2 illustrates a flow chart of a process for generating and maintaining a social graph of belongings.

FIG. 3 illustrates a flow chart of a process for tagging of belongings maintained within a social graph of belongings in photos or posts.

FIG. 4 illustrates a flow chart of a process for tracking and modifying belonging-related posts and photos.

FIG. 5A illustrates an exemplary screen shot of a graphical user interface for modifying a belonging-related post.

FIG. 5B illustrates a screen shot of an exemplary graphical user interface providing a confirmation message to the user.

FIG. 6 illustrates an exemplary social graph of belongings.

FIG. 7 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

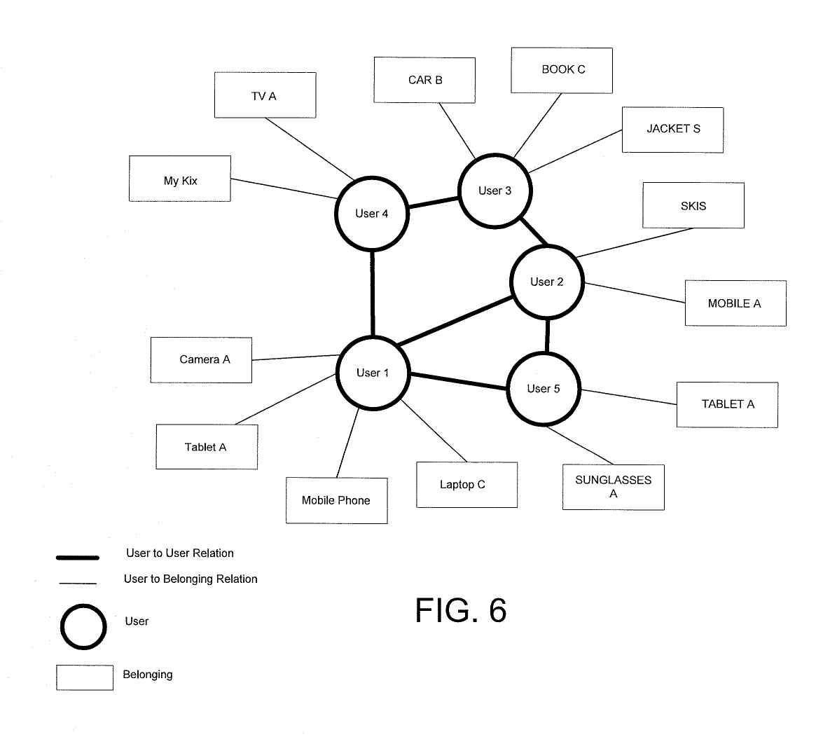

As used herein, “belongings” refer to items owned by a user or items a user has indicated that the user is looking to own, borrow or learn more about. A user's belongings may include items purchased online (e.g., through an internet based retailer), offline (e.g., at regular retail stores), or received as gifts. In accordance with the subject disclosure, a method and a system are provided for building a social graph of belongings of one or more users. In one instance, each user of the system may add one or more belongings, and the system may associate each of the belongings with the user. Thus, in one example of the subject disclosure, a social graph of belongings may define associations between a user and their belongings. In one example, the social graph of belongings may further include associations between users (e.g., by leveraging existing social graphs at one or more remote social networking sites). An exemplary social graph of belongings is described in further detail below with respect to FIG. 6.

In one example, the system may allow users of the system to share activities related to their belonging with their contacts. As used herein, “posts” generally refer to any displayable notification or announcement regarding activities performed with respect to a belonging, including for example, comments, replies, announcements, status updates, digital photos, videos or other appropriate electronic information. Activities related to belongings may include adding a belonging, adding reviews regarding a belonging, adding a description regarding the belonging, modifying one or more attributes of a belonging, sharing the belonging, or indicating a state for the belonging.

Users of remote social networking sites may create associations with one another. These associations may be stored within a social graph at each remote social networking site (e.g., maintained at a remote server). Such user associations may be defined on a user-to-user basis, or as a group of users associated through membership within a group. As used herein, “contacts” refer to a user's friends, social circles, groups and other users that the user is associated with, at one or more remote social networking sites.

As used herein, “social circles” are categories to which a user can assign their social networking contacts and better control the distribution and visibility of social networking messages. In accordance with the subject disclosure, a social circle is provided as a data set defining a collection of contacts that are associated with one another. As used herein, a social circle can be described from the perspective of an individual that is the center of a particular collection of socially interconnected people, or from the aggregate perspective of a collection of socially interconnected people. In some examples, a social circle can have narrowly defined boundaries, all of the members of the social circle may be familiar with one another, and permission may be required for a member to join a social circle. In accordance with the subject disclosure, a user of an electronic device may define a social circle, and the social circle, as a data set defining a collection of contacts, may reflect a real-life social circle of the user.

For example, a user of an electronic device may have different groups of friends, coworkers, and family, and there may be some overlap among those groups (e.g., a coworker who is also considered to be a friend, a family member who is also a coworker). Through the creation and use of social circles, the user can organize and categorize social networking contacts into various different groupings.

The system may leverage existing social graphs maintained at one or more remote social networking sites to facilitate distribution of posts with contacts of a user. For example, one or more remote social networking sites may maintain a social graph of users and their contacts. The system may access social graphs maintained at these remote social networking sites and retrieve contacts of the users of the system. In one instance, the user may indicate membership at one or more remote social networking sites and provide the system with access to these remote social networking sites, for example, through a token. The contacts retrieved by the system may depend upon the specific privacy settings enforced at each of the remote social networking sites.

The system may, upon accessing the remote social networking sites, retrieve information with respect to one or more users of the system and their associated contacts. Using the retrieved contacts, the system can then allow users of the system to share posts related to their belongings with their contacts. The post may then be distributed to the one or more remote social networking sites to be displayed to the user's contacts at the remote social networking site. The system may allow the user to choose specific contacts or groups of contacts at the one or more remote social networking sites with whom the post is shared. In one example, some or all of the remote social networking sites may provide support for selectively sharing posts with one or more contacts of the users.

The system may further provide for tracking the shared posts and/or photos relating to belongings. In one example, each post or photo associated with a belonging may be assigned a unique identifier to facilitate tracking and control of the post or photo once it has been distributed to one or more contacts locally or at one or more remote social networking sites. The unique identifier may be associated with the belonging the post or post is related to and/or a user associated with the specific belonging. In one exemplary instance, the system tracks the post or photo through the unique identifier. For example, the post or photo may be linked with the unique identifier such that after distribution the post or photo may be retrieved and modified using the link, even after being distributed and displayed to contacts.

Additionally, the system may provide for users to create posts related to belongings while interacting with one or more remote social networking sites and associate the posts with the belongings maintained within the social graph of belongings maintained at the system. A “tag” as used herein refers to a link embedded within a post or photo, and associated with a belonging maintained within the social graph of belongings of the system. In one aspect, for example, while at a remote social networking site, a user of the system may create a post (e.g., through a graphical user interface of the remote social networking site) mentioning a belonging. The user may then access a list of his/her belongings maintained within the social graph of belongings, and may tag the belonging within the post and share the tagged post with one or more contacts at the remote social networking site. In one embodiment, this is possible where a client application of the system has been integrated with or is accessible through the social networking site.

Similarly, the system may provide for users to tag belongings within a photo displayed at a remote social networking site and associate the photo, or an area of the photo displaying the item corresponding to the belonging, with the belongings maintained within the social graph of belongings. In one aspect, for example, while at a remote social networking site, a user of the system may add a photo or select an existing photo, the photo displaying a belonging. The user may then access a list of his/her belongings maintained within the social graph of belongings, and may tag the belonging within the photo and allow one or more contacts of the user at the remote social networking site to view the tagged photo. In one embodiment, this is possible where a client application of the system has been integrated with or is accessible through the social networking site. Further, the user may tag photos or posts while interacting directly with the system. For example, the user may upload images, posts or other content and may tag the uploaded content with the belonging in a similar manner as described above.

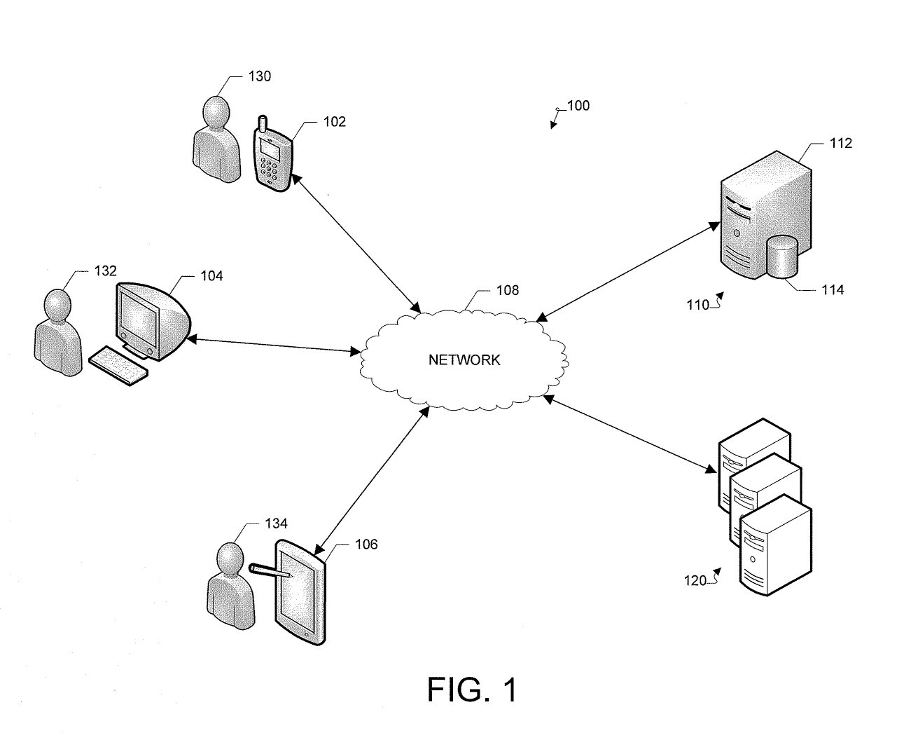

FIG. 1 illustrates an example client-server network environment, which provides for managing belonging-related information using a social graph of belongings. A network environment 100 includes a number of electronic devices 102-106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example embodiments, electronic devices 102-106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In one embodiment, server 110 includes a processing device 112 and a data store 114. Processing device 112 executes computer instructions stored in data store 114, for example, to facilitate managing belonging-related information associated with users interacting with electronic devices 102-106. Server 110 may further be in communication with remote servers 120 either through the network 108 or through another network or communication means.

According to some aspects, remote servers 120 can be any system or device having a processor, a memory and communications capability for hosting various remote social networking sites. In one embodiment, remote servers 120 may be further capable of maintaining social graphs of users and their contacts. The remote social networking sites hosted on the remote server 120 may enable users to create a profile and associate themselves with other users at a remote social networking site. The remote servers 120 may further facilitate the generation and maintenance of a social graph including the user created associations. The social graphs may include, for example, a list of all users of the remote social networking site and their associations with other users of a remote social networking site.

In some example aspects, server 110 and/or one or more remote servers 120 can be a single computing device such as a computer server. In other embodiments, server 110 and/or one or more remote servers 120 can represent more than one computing device working together to perform the actions of a server computer (e.g., cloud computing). In some embodiments, server 110 and/or one or more remote servers 120 may be coupled with various remote databases or storage services. Communications between the client devices 102-106, server 110 and/or one or more remote servers 120 may be facilitated through the HTTP communication protocol. Other communication protocols may also be facilitated, including for example, XMPP communication, for some or all communications between the client devices 102-106, server 110 and one or more remote servers 120.

Users 130-134 may interact with the system hosted by server 110, and/or one or more social networking sites hosted by remote servers 120, through a client application installed at the electronic devices 102-106. Alternatively, the user may interact with the system and the one or more remote social networking sites through a web based browser application at the electronic devices 102-106. Communication between client devices 102-106 and the system, and/or one or more remote social networking sites, may be facilitated through a network (e.g., network 108).

In one embodiment, users 130-134 may interact with the system maintaining a social graph of belongings, which is hosted at the server 110, to manage their belongings. Users 130-134 operating electronic devices 102-106 can manage their belongings, share their belonging-related activities with contacts and control track and modify their posts (e.g., using server 110). For example, users 130-132 may access the system and may create a user profile including a user belonging profile.

In one aspect, upon receiving a user request to interact with the system at a client device (e.g., electronic devices 102-106), the client device may initiate a communication with the system and send a data set including login information of the user. The data set can be transmitted from the user's client device (e.g., electronic devices 102-106) and received at server 110 hosting the system, for user authentication. Once the user is authenticated and access is granted to the user, the system may retrieve and send a data set to the user's client device, for displaying a graphical user interface at the client device operated by the user (e.g., electronic devices 102-106).

The system may further send a query to the user's client device (e.g., displayed within the graphical user interface displayed at the client device) for information regarding one or more social networking sites the user is associated with. Upon receiving a response from the user's client device (e.g., in response to a selection by the user operating the device) the system may initiate establishing communication with one or more remote social networking sites (e.g., through network 108 and remote servers 120). For example, the system may cause the client device to reroute the user to the social networking site. The user's client device may then communicate with the social networking site and send login information to the social networking site, for example, by sending a data set including the login information. The social networking site may authenticate the user using the received data set and may provide the user's client device with a token (e.g., a temporary token). The system hosted at server 110 may then retrieve the token from the user's client device, and may establish communication with one or more servers 120 hosting the remote social networking site using the token. For example, the communication may be facilitated using API calls. Similar steps may be performed for each of the one or more social networking sites associated with the user operating the client device.

Upon being granted access to each of the one or more social networking sites (e.g., through one or more remote servers 120), the system may then issue a request to each remote social networking site associated with the user to retrieve all contacts of the user. In one embodiment, for example, the system (e.g., through server 110) may issue an API call sent to the social networking site (e.g., sent from server 100 to one or more remote servers 120 through network 108). In one aspect, a remote social networking site hosted by one or more remote servers 120, may maintain a social graph comprising all contacts of each of its members, including the user. The social graph may be stored at the storage at the one or more remote servers 120 or may be stored remotely and the one or more remote servers 120 may access the remote storage and retrieve such information. The social networking site may access the social graph and may retrieve the contacts of the user. The social networking site may further retrieve information associated with each contact or the association of the user with the contact, such as privacy preferences. The one or more remote servers 120 hosting the social networking site may provide the system (e.g., through server 110) with data sets including the contacts of the user, and may do so based upon contact information such as the privacy preferences. The server 110, upon receiving the contact information from one or more remote social networking sites, may store the data set including the contact information for each user (e.g., within the belonging profile of the belonging) at the server 110 (e.g., at storage 114). In one aspect, the contact information maintained at the server 110 may be updated periodically, by issuing a request to the one or more remote social networking sites (e.g., through one or more remote servers 120) and receiving updated data sets including user contact information.

The system may then provide the user's client device with an updated graphical user interface including the retrieved contacts of the user. Users 130-132 may interact with the graphical user interface provided by the system and displayed at the user's client device to add one or more belongings to their user belonging profile. Each user may further enter belonging attributes regarding their belongings, such as a belonging name, a belonging image, a description and review regarding the belonging. Additionally, purchase information regarding a belonging may further be entered by a user of the system for each of the user's belongings. For example, information such as purchase receipts, warranty information and other such information may be inputted by the user and may be maintained at the system. Still further, a user may assign a state for each of his/her belonging maintained within the social graph of belongings. A “belonging state” as used herein may refer to a status of the belonging. Belonging states may include, for example, the belonging being owned, borrowed, for sale, reviewed, given away, lent, or being a belonging the user wishes to buy, borrow or own. Each user may additionally organize their belongings into different belonging categories, and may further select contacts with whom activities regarding the newly added belonging may be shared. The entered information may then be sent from the user's client device, as a data set, to the system (e.g., through server 110) and may be stored at the server (e.g., at storage 114). The system (e.g., through server 110) may use the received information within the data set and may update the social graph of belongings maintained at the system (e.g., through server 110).

In addition to receiving belonging information, the system may further receive requests from the user's client device when the user wishes to share activities related to their belongings with contacts. Upon detecting a belonging-related activity performed by the user or upon a request from the user's client device to the system, the system may generate a post related to a belonging. Upon generating the post, the system may issue requests (e.g., API calls) to one or more remote social networking sites to display the post to selected contacts of the user at the one or more remote social networking sites. A data set including the post may be sent to the one or more social networking sites. The social networking site may then use the information included within the data set to display the post at the remote social networking site. Thus, the system may provide a platform where users can organize and share their belongings in a centralized and more effective way.

Additionally, upon establishing communication with the one or more remote social networking sites and/or in response to a user request, the system may request to install a client application at each of the one or more social networking sites, such that users of the system may access the system while interacting with the one or more social networking sites (e.g., through a graphical user interface of each of the one or more remote social networking sites). The system, may, for example, send a data set including a set of calls and/or executable code that may be stored and run from the social networking site when a user requests to access information or services provided by the system maintaining a social graph of belongings.

For example, when a user requests to tag a belonging (e.g., one of the belongings associated with the user) within a photo or post being displayed at a remote social networking site, the user is directed to the system (e.g., through the client application at the remote social networking site), such that the user may interact with the system while at the remote social networking site. The system may receive a request from the remote social networking site (e.g., API calls issued through the client application or directly by the social networking site) to retrieve the list of belongings associated with the user of the system. The system, in response to the request, may retrieve and provide a list of the belongings associated with the user to the client application. The list of belongings may be provided to the user at the remote social networking site and the user may tag the photo or post with a belonging of the list of belongings. In one aspect, in response to the tagging, the system may detect the selection of the belonging and may generate a link to the belonging being tagged and may embed the link within the tagged post or photo such that the tagged belonging will be linked to a belonging profile of the belonging within the social graph of belongings maintained at the system. The link may then be associated with the photo or post, or a selected area within the photo or posts, such that an association may be maintained between the photo or post and the belonging maintained within the social graph of belongings, such that photos and posts associated with a belonging may be retrieved and displayed locally to a user of the system (e.g., so that they may be updated or modified) at the system.

Posts generated with respect to belongings by users of the system may be stored within a database accessible by the system (e.g., at storage 114). In one aspect, such posts may include posts created at a remote social networking site and associated with a belonging by tagging the belonging. A user of the system, may interact with a graphical user interface displayed at the user's client device to request to access posts regarding a belonging, and/or modify the posts regarding a belonging in response to an event (e.g., the belonging being sold, the belonging being lent, updated experience or views regarding the belonging, etc.). Upon receiving the request, the system may access the database storing the posts relating to belongings and may identify all posts associated with a specific belonging and/or all of the belongings of the user, and may generate a data set of the posts. In one aspect, where the posts include posts generated at a remote social networking site and tagged with a belonging of the social graph of belongings, the system may send a request to the social networking site to retrieve the posts to be included within the data set. The data set is then used to update the graphical user interface at the user's client device to display a list of the posts such that the user may view and modify one or more of the posts. Similarly, photos tagged with a belonging may be similarly retrieved and displayed to the user at the system, such that the user can view and modify the photos.

The system may provide users with the ability to easily share information about their belongings, know and control what is shared and with whom, preserve valuable information about their belongings, organize all the information shared regarding their belongings, including reviews and comments in one place, share their wishes to borrow or buy an item with their contacts, seek recommendations from their contacts, sell, buy, give away, borrow and led their belongings, and search and browse belongings of their contacts.

While each of the users 130-134 may interact with the system through their respective client device 102-106, for exemplary purposes the interactions between the users and the system is hereinafter described with reference to user 130. In many instances, each user 130-134 may interact with the system in the same or similar manner described below with respect to user 130.

In one exemplary embodiment, user 130 interacting with electronic device 102 may register with the system hosted by server 110 and create a user profile. In one embodiment, upon registration, user 130 may access the system and add one or more belongings. User 130 may further share activities performed with respect to those belongings with his/her contacts on one or more remote social networking sites directly through the system hosted by server 110.

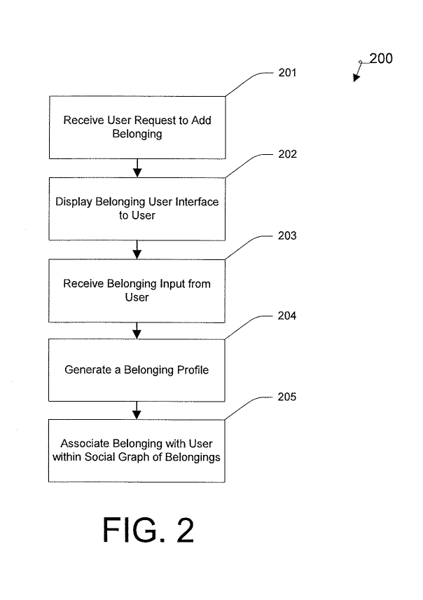

FIG. 2 illustrates a flow chart illustrating a process 200 for generating and maintaining a social graph of belongings. The process 200 begins in step 201 when the system receives a user request to add a new belonging, for example, from user 130. In some aspects, the request may be received when user 130 selects to add a belonging, for example, by selecting the add button when viewing a graphical user interface of a belonging profile or when viewing a graphical user interface of a user profile (e.g., a user belonging profile displaying the one or more belongings associated with the user within the social graph of belongings), while interacting with the system. Alternatively, the system may receive the user request to add a new belonging when user 130 selects a suggested belonging provided to the user by the system.

Next, in step 202 the system displays a graphical user interface to user 130 for adding a new belonging. User 130 may then enter attributes regarding the belonging, such as a name of the belonging, an image of the belonging, contacts to share activities related to belongings with, belonging categories associated with the belonging, a belonging sharing preference, belonging description, belonging review and ranking, belonging state and/or belonging purchase information.

In step 203, the system receives a belonging input from the user. For example, the user may select a save item button, and the information regarding the belonging may then be received by the system. Next, the process continues to step 204 in which the system generates a belonging profile based upon the information entered by user 130 and received in step 203. Next, in step 205, the system associates the belonging and/or the belonging profile with user 130. As described above, a social graph of belongings may be generated and maintained by the system. The social graph of the belongings, according to some aspects, includes associations between a user and belongings of that user for all users of the system. In step 205, the system may add the new belonging entry into the social graph of belongings as a belonging of the user 130, thus expanding the social graph of belongings through the new user-belonging association.

In some aspects, once user 130 and the belonging inputted in step 203 have been associated, the system may then generate and distribute posts related to the belonging to one or more contacts of user 130. In one embodiment, user 130 selects one or more contacts and/or groups of contacts, which the user wishes to share the user's belonging activities with. In some embodiments, adding the belonging is detected as a belonging-related activity and thus the system may initiate the process for generating and sharing a post related to the belonging with the contacts selected by the user.

Upon, establishing a profile within the system, and adding one or more belongings, the user of the system (e.g., user 130) may access the associations maintained within the social graph of belongings regarding his/her one or more belongings to tag photos and/or posts being shared with contacts of the user locally and/or at one or more remote social networking sites. For example, user 130, while interacting with a graphical user interface of a remote social networking site displaying a photo or post, may access a list of his/her belongings (e.g., those associated with the user within the social graph of belongings) and may request an area of the post or photo to be tagged with a specific belonging of user 130. Similarly, while interacting with a graphical user interface of the system, user 130 may similarly request to tag a photo or post with a belonging. In one aspect, the photo may be uploaded from a remote storage, and may include any image format acceptable by the system and/or remote social networking site. A post, similarly, may include various text strings including links to a web page, images or other items and may be created by the user, generated by the system, or uploaded from a remote source.

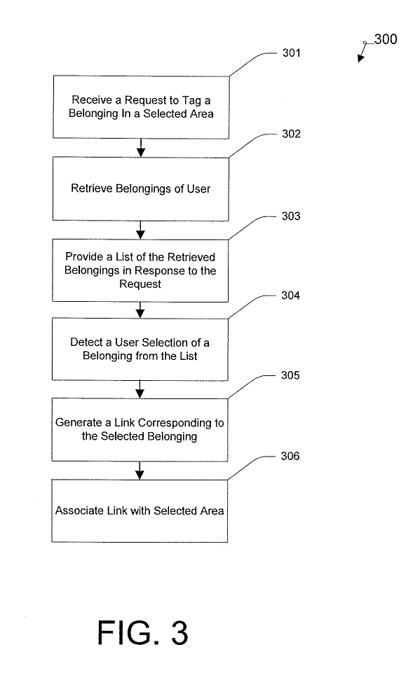

FIG. 3 illustrates a flow chart illustrating a process 300 for tagging of belongings maintained within a social graph of belongings in photos or posts. The process begins in step 301 when the system receives a request from a user of the system (e.g., user 130) to tag a selected area with a belonging. The selected area may be an area within an image, a string of text such as a post, or any other area selectable by a user. The selected area may represent a belonging, and may, for example, include a photo, or an area within a photo, corresponding to an image of a belonging and/or a text string or character corresponding to or including a name, image or other graphical representation of a belonging.

In one embodiment, the request may be received upon user 130 indicating a desire to tag a photo or post, while interacting with a graphical user interface of a remote social networking site. The user may, while interacting with the remote social networking site, select to tag a photo or post, and the system may be notified of the user's desire to view possible belonging and to select a belonging to tag the photo or post. A system client application integrated with the remote social networking site, for example, may detect a request by user 130 to tag a belonging when the user interacts with a graphical user interface of the belonging and may send the request to the system. In another aspect, the remote social networking site may be in communication with the system, and upon receiving a user request to tag an area with a belonging may forward a request to the system. The request may be sent to the system, for example, through one or more API calls. Alternatively, the request may be received at the system when the user directly interacts with a graphical user interface of the system.

The request to tag a belonging may be received (e.g., at the remote networking site or locally at the system) in a variety of ways including, for example, when the user selects to tag a photo or post, when the user of the system (e.g., user 130) requests to view a list of belongings available for tagging of photos and posts, the user inputting a character or text string indicating that the user wishes to tag a photo with a belonging or other similar actions understood by the system and/or the remote social networking site as a request to tag a photo or post, or a selected area within a photo or post, with a belonging.

Upon receiving the request at the system (e.g., when the request is received from the social networking site or a client application and/or locally detected at the system), the process then continues to step 302. In step 302, the system retrieves belongings associated with user 130. The belongings of users of the system are maintained within a social graph of belongings and may be stored at one or more databases (e.g., storage 114) accessible by the system. The system, upon receiving the request, may identify the user associated with the request and access the databases storing the belongings associated with the users of the system to retrieve the belongings of the identified user of the system (e.g., user 130). The belongings retrieved include belongings added by the user and/or associated with the user within the social graph of belongings. In one aspect, in addition to the belongings of user 130, the system may further provide the user with belongings associated with the user through being shared with the user by contacts of user 130 and/or belongings of contacts of user 130. For example, the system may recognize that user 130 has access to viewing information regarding his/her belongings as well as belonging of his/her contacts and/or belongings shared with user 130 by other users of the system (e.g., users 132 and 134), and may retrieve those belongings in addition to the belongings of user 130 as indicated within the social graph of belongings.

In step 303, the system provides a list of the belongings to user 130 in response to the request. In aspects where the request from the user 130 is detected while the user is interacting with a remote social networking site, the system may transmit the list of the belongings retrieved in step 302 to the remote social networking site to be provided to the user. Alternatively, if the request is detected when user 130 interacts with a graphical user interface of the system, the system may generate a list of belongings and may display the belongings to user 130. User 130, upon viewing the list of belongings, may select a particular belonging to tag the photo or post. Alternatively, the user may begin typing a partial name of a belonging and the list may appear in response to the partial name being entered.

In step 304, the system detects an indication of a user selection of a belonging from the list of belongings. The detection may occur when the user receives a message from the remote social networking site and/or the client application at the remote social networking site indicating that the user has selected a particular belonging for tagging the photo or post. Alternatively, the request may be detected when the system detects that the user has selected a belonging while interacting with a graphical user interface of the system.

In response to receiving the user selection, in step 305, the system generates a link corresponding to the belonging. The link to the post may be selectable and upon selection may access and display the belonging profile of the belonging.

In step 306, the link may be associated with the photo or post, or the specific area within the photo or post, selected by user 130. In one aspect, during step 306 the system may further associate the post or photo with a unique identifier. The system may track the post or photo through the unique identifier. For example, the post or photo may be associated with the unique identifier such that the post or post may be retrieved and modified using the unique identifier, even after the post or photo has be distributed and displayed to contacts.

The post or photo may further be stored within a database at the system or accessible by the system, such that the post or photo may later be retrieved (e.g., using the link and/or the unique identification associated with the post or photo). The system may query the social networking site or determine information regarding the post or photo, such as which contacts of the user the post or photo is shared with and the other individuals or belongings tagged within the post, and may store such information and associate the information with the photo or post. The link to the belonging may be embedded within the post or photo, at the selected area of the photo or post (e.g., the area corresponding to the belonging) and/or may be displayed along with the photo or post.

Upon being displayed at the remote social networking site or locally at the system, contacts of user 130 may view the tagged photo or post and may enter feedback or reviews regarding the post or photo while interacting with the remote social networking site and/or a graphical user interface of the system. The comments and feedbacks may be associated with the post or photo and may be retrieved and stored in the database at the system and associated with their respective photo or post. For example, each post or photo may be associated with a unique identifier, and posts and comments created by contacts in connection with the post may be associated with the unique identifier of their respective photo or post such that the comments and posts associated with the post or photo may be retrieved from the database and/or remote social networking site and displayed to the user locally when interacting with the graphical user interface of the system.

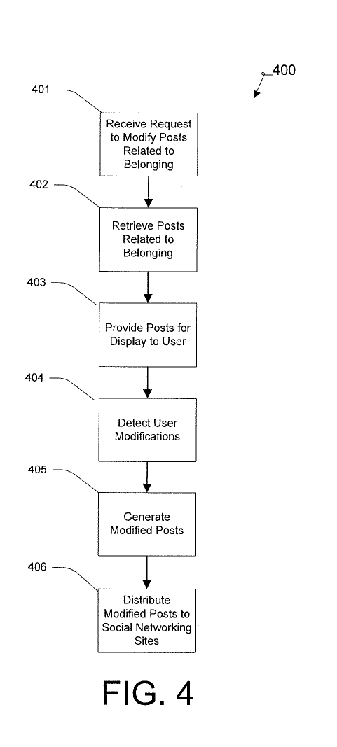

FIG. 4 illustrates a flow chart of a process 400 for tracking and modifying belonging-related posts or photos. As described above, the posts and/or photos may include posts or photos created remotely at a remote social networking site or locally at the system, and may include photos or posts generated in response to belonging-related activities and/or tagged with a belonging. The photos or posts may be already distributed and displayed to contacts locally and/or at one or more remote social networking sites. The process is herein described with respect to posts, but it should be understood that a similar process may be performed with respect to photos tagged with a belonging or otherwise relating to a belonging.

The process 400 begins in step 401 where the system receives a request to modify one or more posts. In one embodiment, the request may be for retrieving all posts related to a user, while in other embodiments, the request may be for retrieving posts related to a belonging of the user. Such a request may be received, for example, when the user requests to retrieve and modify all posts, posts related to a belonging, or may be automatically detected when a modification is made with respect to a belonging, such as when the belonging is deleted, given away or sold, or when the user is no longer associated with the system (e.g., when the user deactivates his/her account).

In step 402, the system retrieves posts related to the belonging. In one instance, all posts related to the belonging may be retrieved, while in other instances, only specific posts may be retrieved. In step 402, the system may detect posts associated with the request and retrieve those posts. In one aspect, the one or more posts may be stored within a database and accessible to the system. As described above, each post may be assigned a unique identifier and may further include a link to the user and the belonging. The system may use the unique identifier and/or the links embedded within the post to retrieve the post.

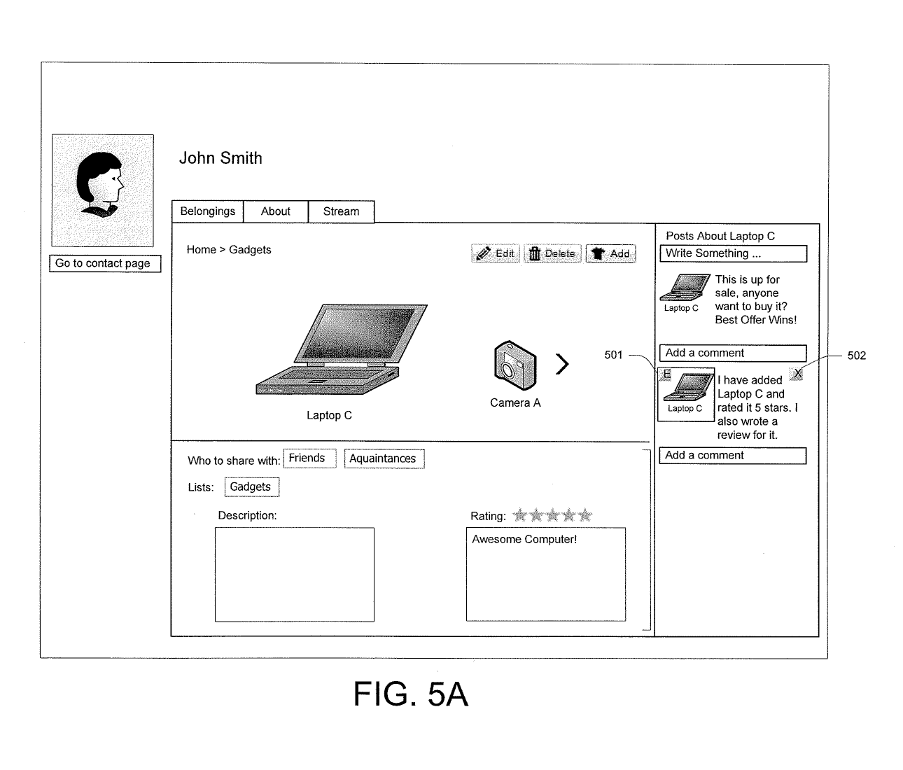

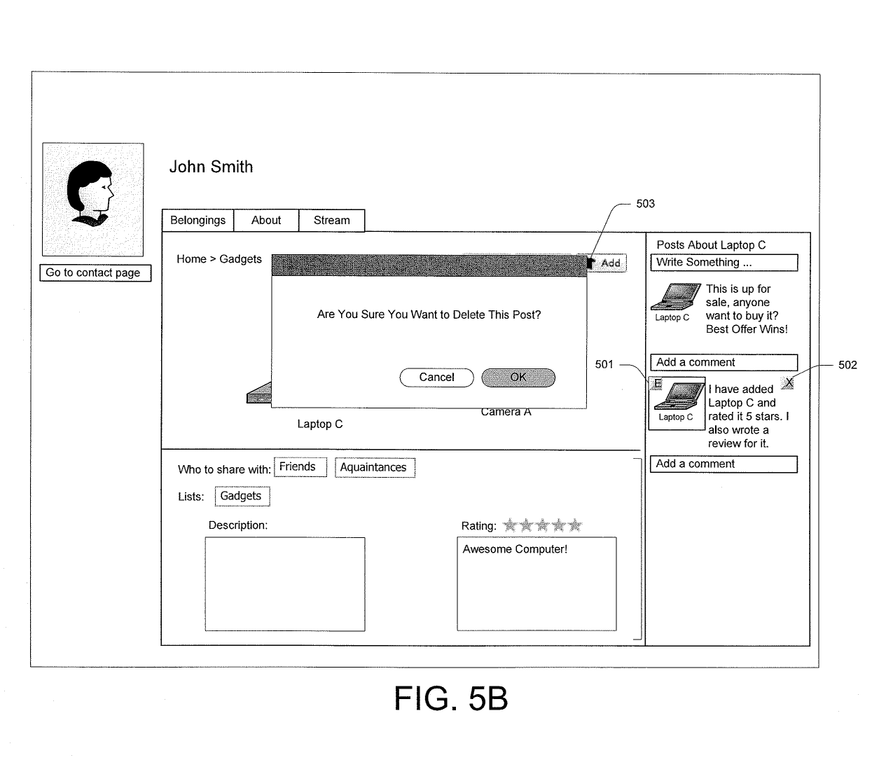

In step 403, all retrieved posts may be provided for display to the user. The user may then view the posts and modify one or more posts, including modifying the text of the post and/or the image included within the post. Alternatively, in step 403, the system may automatically modify one or more of the retrieved posts. In one exemplary instance, step 403 may not be performed where the posts are modified in response to a system detection and seamlessly without notification to the user. An exemplary graphical user interface displayed to the user for modifying a belonging related post is illustrated below with respect to FIGS. 5A and 5B.

The modifications to the posts are detected in step 404. The modifications may be user generated, system generated or may be a combination thereof. In step 405, the system generates modified posts according to the detected modifications. In some instances, the modified posts each comprise a link to the user and a link to the belonging associated with the modified posts. The modified posts may each be associated with their respective unique identifier, or may alternatively be associated with a new unique identifier.

Next, in step 406 of process 400 the system distributes the modified posts to be displayed to one or more contacts. The posts may be distributed to one or more remote social networking sites to be displayed to selected contacts (e.g., contacts which the original post was shared with) or may be locally displayed to contacts of the user. During step 406, the system may determine contacts to share the post with. The contacts may be stored within the belonging profile of the belonging or may alternatively be stored with respect to each post. In one embodiment, the determined contacts may be associated with one or more remote social networking sites. In one embodiment, prior to sending the modified posts to one or more remote social networking sites and/or displaying the posts locally, the system may determine whether the user should be prompted before the posts are shared (e.g., based on user settings with respect to the specific belonging associated with the post) and the system may prompt the user before distributing the post and may distribute the posts when it is determined that the user has authorized sharing the modified post with one or more contacts (e.g., to be locally displayed at the system and/or transmitted to one or more remote social networking sites).

The one or more remote social networking sites may provide API functionality for receiving and posting posts. In such embodiments, the system generates an API call to each of the one or more remote social networking sites to display the post. In one instance, the post may be displayed along with other posts by user 130 within the one or more remote social networking sites and shared with the one or more determined contacts. The post may further be stored within a database maintained by the system. A date and time associated with the posts (e.g., the time the post was created, generated or stored) may be stored with the post for later retrieval and display within a belonging-related stream.

Upon being displayed at the remote social networking site, the selected contacts may then enter feedback or reviews regarding the post at the social networking site. The comments and feedbacks are associated with the post and may be retrieved and stored in the database of posts and comments along with the post. For example, each post may include a unique identification, and posts and comments created by users in connection with the post may be associated with the unique identification such that the comments and posts associated with the post may be retrieved from the remote social networking site and displayed to the user locally when interacting with the graphical user interface of the system.

FIG. 5A illustrates a screen shot of an exemplary graphical user interface for modifying a belonging-related post. In the exemplary graphical user interface of FIG. 5A the user may modify the post from a belonging-related stream displaying one or more posts related to a specific belonging. The user may select an icon next to each post (e.g., icon 501) for editing the post. Upon selecting the icon, the post may be presented to the user in editable form and the user may edit the post. Similarly, a second icon (e.g., icon 502) may be provided to the user for deleting the post. In one example, a single icon may be provided in lieu of icons 501 and 502 (e.g., providing the user with a drop down menu). Upon selecting the icon and performing an edit or deletion, the user may be presented with a confirmation message for confirming the edit or deletion of the post. FIG. 5B illustrates a screen shot of an exemplary graphical user interface providing a confirmation message 503 to the user. Upon receiving confirmation from the user, the system detects the modification to the post.

FIG. 6 illustrates an exemplary social graph of belongings. As illustrated, the social graph of belongings includes one or more users. Each of the one or more users is associated with one or more belongings. Furthermore, as illustrated, the social graph of belongings may further define associations between the user and other users within the social graph of belonging (i.e., his/her contacts). The exemplary social graph of belongings includes associations among users 1-5 and further defines associations between each of the users 1-5 and one or more belongings.

More specifically, user 1 is associated with user 2, user 4 and user 5. Furthermore, User 1 is associated with belongings including “Camera A”, “Tablet A”, “Mobile Phone” and “Laptop C”. User 2 is illustrated as being associated with user 1, user 3 and user 5, and with belongings including “SKIS” and “MOBILE A”. User 3 is illustrated as being associated with user 2 and user 4, and further with belongings including “CAR B”, “BOOK C” and “JACKET S”. User 4 is illustrated as associate with user 1 and user 3 and belongings including “TV A” and “My Kix”. Finally, User 5 is illustrated as being associated with user 1 and user 2 and with belongings including “TABLET A” and “SUNGLASSES A”.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

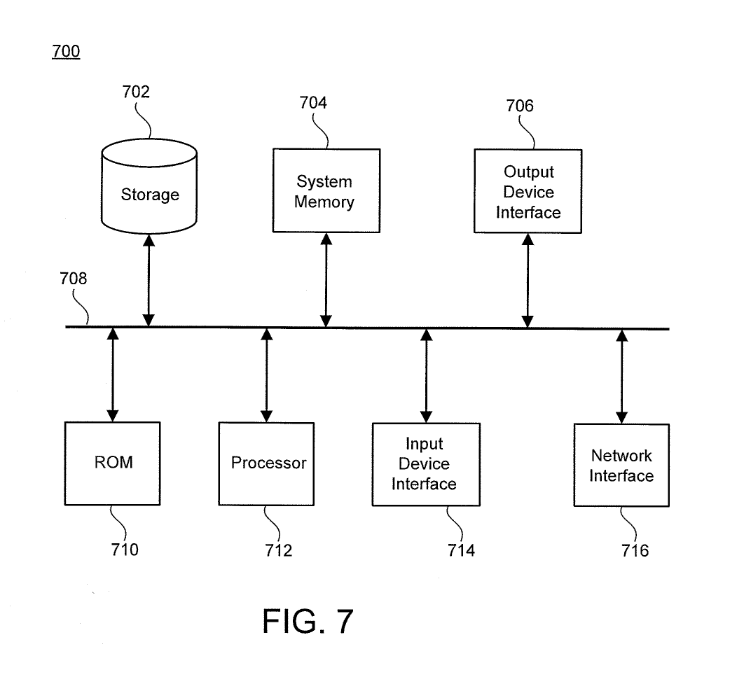

FIG. 7 conceptually illustrates an electronic system with which some implementations of the subject technology are implemented. Electronic system 700 can be a computer, phone, PDA, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for processing multimedia items in accordance with some implementations. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system may be interconnected by any form or medium of digital data communication, e.g., a communication network. While several components or steps are described as being performed by the system, it should be understood that various components and steps may be performed by different systems in communication with one another, e.g., through a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for tagging of belongings maintained within a social graph of belongings in photos and posts, the method comprising:
receiving a request to tag a belonging within a selected area of a display from a user of a system;
providing, in response to the request, a list of belongings comprising the one or more belongings associated with the user within the social graph of belongings, wherein the social graph of belongings defines an association between each of the one or more users and one or more belongings;
receiving an indication of a user selection of a first belonging from the list of belongings;
generating a link corresponding to the first belonging in response to receiving the indication of the user selection; and
associating the link with the selected area

2. The method of claim 1, wherein the selected area comprises an area of one of an image, photo or a post.

3. The method of claim 2, wherein the one of the photo and the post is displayed to the user at a remote social networking site.

4. The method of claim 2, wherein the one of the photo and the post is displayed to the user at a graphical user interface of the system.

5. The method of claim 2, further comprising:
retrieving the one of the photo and the post;
associating the one of the photo and the post with a unique identifier corresponding to the first belonging; and
storing the one of the photo and the post associated with the unique identifier.

6. The method of claim 1, wherein the receiving the request comprises receiving a request from a remote social networking site, the request indicating a user request received at the remote social networking site to tag the belonging within the selected area of the display.

7. The method of claim 1, wherein the selected area corresponds to the first belonging.

8. The method of claim 1, wherein the link is selectable and configured to access and display a belonging profile associated with the first belonging upon selection.

9. The method of claim 8, wherein the belonging profile comprises attributes of the first belonging including one or more of a belonging name, a belonging image, a belonging sharing preference, a belonging review, a belonging rating, a belonging description, one or more contacts and a belonging category.

10. The method of claim 1, wherein the list of belongings further comprises one or more belongings associated with one or more other users of the one or more users and shared with the user.

11. A system for tagging of belongings maintained within a social graph of belongings in photos and posts, the system comprising:
one or more processors; and
a machine-readable medium comprising instructions stored therein, which when executed by the processors, cause the processors to perform operations comprising:
receiving a request to tag a belonging within one of a photo or a post from a user of a system;
providing one or more belongings to the user in response to the request, wherein the one or more belongings are referenced within a social graph of belongings, wherein the social graph of belongings defines an association between one or more users including the user of the system and one or more belongings;
receiving a selection of a first belonging of the provided one or more belongings from the user;
generating a link corresponding to the first belonging in response to the selection; and
associating the link with the one of the photo and the post.

12. The system of claim 12, wherein the receiving the request comprises receiving an indication of a user requesting to tag at least an area of the one of the post and photo with a belonging.

13. The system of claim 12, wherein the receiving the request comprises receiving a request indicating a request from the user from a remote social networking site.

14. The system of claim 12, wherein the one or more belongings includes the one or more belongings associated with the user within the social graph of belongings.

15. The system of claim 14, wherein the one or more belongings further includes one or more belongings associated with one or more others users within the social graph of belongings and shared with the user.

16. The system of claim 12, the operations further comprising:
retrieving the one of the photo or the post;
associating the one of the photo or the post with a unique identifier corresponding to the first belonging; and
storing the one of the photo or the post associated with the unique identifier.

17. The system of claim 12, wherein the link is selectable and configured to access and display a belonging profile associated with the first belonging upon selection.

18. The system of claim 12, wherein the one of the photo or the post includes at least an area including a graphical representation of the first belonging.

19. A machine-readable medium comprising instructions stored therein, which when executed by a machine, cause the machine to perform operations comprising:
receiving a request to tag a belonging within a selected area of one of a photo or a post from a user;
retrieving a list of belongings, the list of belongings comprising the one or more belongings associated with the user within a social graph of belongings, wherein the social graph of belongings defines an association between each of the one or more users including the user and one or more belongings, each of the one or more belongings being associated with a belonging profile;
providing the list of belongings in response to the request;
receiving a selection of a first belonging from the list of belongings from the user;
generating a link corresponding to the first belonging in response to the selection, wherein the link is selectable and configured to access and display the belonging profile associated with the first belonging upon selection; and
associating the link with the selected area.

20. The machine-readable medium of claim 19, wherein the receiving the request comprises receiving a request indicating a request from the user from a remote social networking site.
